(19) United States
(12) Patent Application Publication
(10) Pub. No.: US 2024/0218211 A1
(43) Pub. Date: Jul. 4, 2024

(54) MOISTURE-CURABLE HOT-MELT ADHESIVE COMPOSITION AND USE THEREOF

(71) Applicant: Everlight Chemical Industrial Corporation, Taipei City (TW)

(72) Inventors: Jiu-Tai WEI, Taoyuan City (TW); Jui-Chi LIN, Taoyuan City (TW); Tzu-Heng KO, Taoyuan City (TW)

(21) Appl. No.: 18/501,508

(22) Filed: Nov. 3, 2023

(30) Foreign Application Priority Data
Dec. 30, 2022 (TW) 111150802

(51) Int. Cl. C09J 7/35; C09J 133/06

(52) U.S. Cl. CPC C09J 7/35; C09J 133/066; C09J 2301/304; C09J 2301/312

(57) ABSTRACT

A moisture-curable hot-melt adhesive composition comprises a polymer obtained by reacting the following components: 20 wt % to 60 wt % of bio-based polyester polyol; 1 wt % to 30 wt % of polycaprolactone polyol; 5 wt % to 50 wt % of petroleum-based polyester polyol; and 15 wt % to 25 wt % of polyisocyanate; wherein the bio-based polyester polyol comprises a product of a dicarboxylic acid derived from biomass and a diol derived from biomass or petroleum; and the dicarboxylic acid is sebacic acid, succinic acid, or a combination thereof. A use of the aforesaid moisture-curable hot-melt adhesive composition is also provided.

### CROSS-REFERENCE TO RELATED APPLICATIONS

This application claims the benefits of the Taiwan Patent Application Serial Number 111150802, filed on Dec. 30, 2022, the subject matter of which is incorporated herein by reference.

### BACKGROUND OF THE INVENTION

### Field

The present invention provides a moisture-curable hot-melt adhesive

composition and a use thereof. More specifically, the present invention provides a moisture-curable hot-melt adhesive composition using sustainable materials derived from biomass and a use thereof.

### Description of Related Art

The United Nations has announced the sustainable development goals, hoping to promote economic prosperity while also protecting the earth. Therefore, developing products using sustainable materials is one of the goals of various manufacturers and major brands. For example, functional textiles and outdoor sports goods, shoe upper composites and shoe lining fabrics, home decoration curtains and bedding products, car interior seats and lights, green building window frames and seam-filling applications, lamination and splicing of plastic and wooden floors, and narrow-frame screen glue in the electronics industry all hope to introduce sustainable materials (for example, materials from biomass sources).

For example, polyols derived from biomass can be used to prepare polyurethane for moisture-curable hot-melt adhesive compositions. However, when biomass-derived polyols are used as raw materials, their application characteristics do not meet industry expectations, and the performance becomes worse as the addition amount increases.

Therefore, it is desirable to provide a novel moisture-curable hot-melt adhesive composition to solve the aforesaid problems.

### SUMMARY OF THE INVENTION

An object of the present invention is to provide a moisture-curable hot-melt adhesive composition and a use thereof, wherein the moisture-curable hot-melt adhesive composition comprises biomass-derived sustainable materials, and the formed adhesive material has good stress or elongation.

The moisture-curable hot-melt adhesive composition provided by the present invention comprises: a polymer obtained by reacting the following components: 20 wt % to 60 wt % of bio-based polyester polyol; 1 wt % to 30 wt % of polycaprolactone polyol; 5 wt % to 50 wt % of petroleum-based polyester polyol; and 15 wt % to 25 wt % of polyisocyanate, wherein the bio-based polyester polyol comprises a product of a dicarboxylic acid derived from biomass and a diol derived from biomass or petroleum; and the dicarboxylic acid is sebacic acid, succinic acid, or a combination thereof.

The moisture-curable hot-melt adhesive composition of the present invention comprises a polymer obtained by reacting the bio-based polyester polyol, the polycaprolactone polyol, the petroleum-based polyester polyol and the polyisocyanate, which is a bio-based polyurethane (PUR) adhesive with a —NCO reactive group. Herein, the used polyester polyol is a sustainable material derived from biomass, which is obtained by reacting the dicarboxylic acid derived from biomass and the diol derived from biomass or petroleum, and the moisture-curable hot-melt adhesive composition of the present invention can be used in various industries that focus on sustainable development. In addition, biomass materials often suffer from insufficient stress in performance; but the polymer in the moisture-curable hot-melt adhesive composition of the present invention further includes polycaprolactone polyol, thereby increasing the stress or elongation of the formed adhesive material. Meanwhile, the moisture-curable hot melt adhesive composition of the present invention exhibits good adhesion to a variety of materials, such as textiles, wood, glass, metal, and plastics.

In the present invention, the bio-based polyester polyol may comprise the product of the dicarboxylic acid derived from biomass and the diol derived from biomass or petroleum. The dicarboxylic acid derived from biomass may be sebacic acid, succinic acid, or a combination thereof. Herein, sebacic acid, for example, may be obtained from vegetable oils (for example, castor oil) by performing a known cleavage reaction using caustic alkali; and succinic acid, for example, may be obtained by fermenting corn, sugar cane, cassava, sago palm, etc. by a conventional method.

The diol derived from biomass or petroleum may be one selected from the group consisting of ethylene glycol, diethylene glycol, 1,3-propanediol, 1,2-propanediol, 1,3-butanediol, 1,4-butanediol, pentanediol, 2,4-diethyl-1,5-pentanediol, 3-methyl-1,5-pentanediol, hexanediol, neopentyl glycol, 1,4-cyclohexanediol, 1,10-decanediol, dimer diol, isosorbide and hexamethylene glycol, or a combination thereof. In one embodiment, the diol derived from biomass or petroleum may be 1,3-propanediol, 1,4-butanediol or a combination thereof. Herein, the preparation of the diol derived from biomass or petroleum can refer to the content disclosed in CN110546205B.

In the present invention, the bio-based polyester polyol has a molecular weight (Mw) ranging from 1000 to 5000, 2000 to 4000 or 2000 to 3000. In one embodiment, the molecular weight of the bio-based polyester polyol may be about 3000, but the present invention is not limited thereto. In addition, in the present invention, the OH value (OHv: mg OH/g) of the bio-based polyester polyol may range from 24 to 61. Furthermore, in the present invention, the acid value (mg OH/g) of the bio-based polyester polyol may be less than 1. When the molecular weight of the bio-based polyester polyol is too large, the OH value thereof is low, resulting in poor reactivity of the bio-based polyester polyol. Thus, the effect on increasing the stress or elongation of the adhesive material formed by the moisture-curable hot melt adhesive composition is limited.

In the present invention, the petroleum-based polyester polyol may comprise a product of a polybasic acid and a compound with two or more hydroxyl groups. Herein, the compound with two or more hydroxyl groups may be an organic compound with two, three or four hydroxyl groups. For example, the compound with two or more hydroxyl groups may be one selected from the group consisting of ethylene glycol, diethylene glycol, 1,3-propanediol, 1,2-propanediol, 1,3-butanediol, 1,4-butanediol, pentanediol, 2,4-diethyl-1,5-pentanediol, 3-methyl-1,5-pentanediol, hexanediol, neopentyl glycol, 1,4-cyclohexanediol, 1,10-decanediol, dimer diol, isosorbide, hexamethylene glycol, glycerin and trimethylolpropane, or a combination thereof. In one embodiment, the compound with two or more hydroxyl groups may be hexanediol and neopentyl glycol, but the present invention is not limited thereto. In addition, the polybasic acid may be a dibasic organic acid, a tribasic organic acid or a quaternary organic acid. For example, the polybasic acid may be one selected from the group consisting of succinic acid, adipic acid, glutaric acid, pimelic acid, suberic acid, dimer acid, sebacic acid, undecanedicarboxylic acid, lauric acid, hexahydroterephthalic acid, phthalic acid, phthalic anhydride, isophthalic acid and terephthalic acid, or a combination thereof. In one embodiment, the polybasic acid may be phthalic anhydride, but the present invention is not limited thereto.

In the present invention, the molecular weight (Mw) of the petroleum-based polyester polyol is not particularly limited, and may range from, for example, 500 to 5000, 500 to 4000, 500 to 3000, 500 to 2000 or 500 to 1500. In one embodiment, the molecular weight of the petroleum-based polyester polyol may be about 1000, but the present invention is not limited thereto.

In the present invention, the polycaprolactone polyol may be petroleum-based polycaprolactone polyol. In the present invention, for the polycaprolactone polyol, a catalyst is used to catalyze the ring-opening polymerization of caprolactone to prepare polycaprolactone. The starting alcohol used in the preparation of the polycaprolactone polyol is usually one of neopentyl glycol (NEO), diethylene glycol (DEG), 1,4-butanediol (BDO), 1,6-hexanediol (HDO), trimethylolpropane (TMP), pentaerythritol (PENTA), ethylene glycol (MEG), etc. In one embodiment of the present invention, the polycaprolactone polyol is the reaction product of caprolactone and 1,4-butanediol as the starting alcohol.

In the present invention, the polycaprolactone polyol may have a molecular weight (Mw) ranging from 1000 to 5000, 2000 to 4000 or 3000 to 4000. In one embodiment, the polycaprolactone polyol may have the molecular weight of about 3000. In another embodiment, the polycaprolactone polyol may have the molecular weight of about 4000. However, the present invention is not limited thereto. In addition, in the present invention, the OH value (OHv: mg OH/g) of the polycaprolactone polyol may range from 24 to 61. Furthermore, in the present invention, the acid value of the polycaprolactone polyol (mg OH/g) may be less than 1. When the molecular weight of the polycaprolactone polyol is too large, the OH value thereof is low, resulting in poor reactivity of the polycaprolactone polyol. Thus, the effect on increasing the stress or elongation of the adhesive material formed by the moisture-curable hot melt adhesive composition is limited.

In the present invention, the polyisocyanate may be an aliphatic or cycloaliphatic polyisocyanate selected from the group consisting of 4,4′-methylene diphenyl diisocyanate (4,4′-MDI), tolylene diisocyanate (TDI), 1,5-pentane diisocyanate (PDI), aromatic polyisocyanate such as 1,5-naphthalene diisocyanate (NDI), hexamethylene diisocyanate (HDI), cyclohexane diisocyanate, isophorone diisocyanate (IPDI), 4,4′-diisocyanato dicyclohexylmethane (H₁₂MDI), m-xylylene diisocyanate (XDI) and meta-tetra-methylxylene diisocyanate (m-TMXDI), or a combination thereof. In one embodiment, the polyisocyanate may be 4,4′-methylene diphenyl diisocyanate (4,4′-MDI), but the present invention is not limited thereto, and other polyisocyanates that can react with polyols to form polyurethanes may also be used in the present invention.

In the present invention, the equivalent ratio of isocyanate groups to hydroxyl groups may range from 1.7 to 3.5.

In the present invention, the polymer in the moisture-curable hot adhesive melt composition is a biomass product, and a biomass content of the polymer may range from 20% to 60%.

Moreover, the present invention further provides a use of the aforesaid moisture-curable hot-melt adhesive composition, for adhesion of textile, wood, glass, metal, plastic or a combination thereof.

Other novel features of the disclosure will become more apparent from the following detailed description when taken in conjunction with the accompanying drawings.

### DETAILED DESCRIPTION OF THE INVENTION

The following is specific embodiments to illustrate the implementation of the present invention. Those who are familiar with this technique can easily understand the other advantages and effects of the present invention from the content disclosed in the present specification. The present invention can also be implemented or applied by other different specific embodiments, and various details in the present specification can also be modified and changed according to different viewpoints and applications without departing from the spirit of the present invention.

It should be noted that, in the present specification, when a component is described to have an element, it means that the component may have one or more of the elements, and it does not mean that the component has only one of the element, except otherwise specified.

In the present specification, except otherwise specified, the term “or” used in the specification and the appended claims generally includes the meaning of “and/or”.

In the present specification, the terms “almost”, “about” and “approximately” mean within ±20%, within ±10%, within ±5%, within ±3%, within ±2%, within ±1%, or within ±0.5% of a given value or range. The quantity given here is an approximate quantity, that is, without specifying “almost”, “about” and “approximately”, it can still imply “almost”, “about” and “approximately”. In addition, the term “in the range from the first value to the second value” or “in the range between the first value and the second value” means that the range includes the first value, the second value and a value between the first value and the second value.

Different embodiments of the present invention are provided in the following description. These embodiments are meant to explain the technical content of the present invention, but not meant to limit the scope of the present invention. Unless otherwise specified, in the following preparation examples, embodiments and comparative embodiments, the temperature is shown by Celsius, the parts and percentages are shown by weight. The relationship between parts by weight and parts by volume is like the relationship between kilograms and liters.

In the following Comparative embodiment 1 and Embodiments 1 to 3 and 6, the bio-based polyester polyol is obtained by copolymerizing succinic acid and 1,3-propanediol, in which both succinic acid and 1,3-propanediol are 100% biomass materials. In the following Embodiments 4 and 5, the bio-based polyester polyol is obtained by copolymerizing sebacic acid and 1,4-butanediol, in which sebacic acid is derived from plants and 1,4-butanediol is derived from petroleum, so 67% of the bio-based polyester polyol is biomass materials. Herein, the methods for obtaining succinic acid, sebacic acid, 1,3-propanediol and 1,4-butanediol are as described above and are not described again.

### Comparative Embodiment 1

37.5 g of bio-based polyester polyol (obtained from the copolymerization of succinic acid and 1,3-propanediol, and having the molecular weight of 3000), 37.5 g of petroleum-based polyester polyol (obtained from the copolymerization of phthalic anhydride and diethylene glycol, and having the molecular weight of 2000) were placed in a reaction bottle, heated to 100° C. under mechanical stirring, and dried under reduced pressure. After the temperature was cooled to 60° C., 25.0 g of 4,4′-MDI (isocyanate/hydroxyl ratio is 3.20) was added for reaction. The isocyanate group content was detected according to the ASTM D5155 method to detect the reaction endpoint. The reaction was stopped, and the product was collected and packaged to obtain the moisture-curable hot melt adhesive composition of the present comparative embodiment. Herein, the biomass content of the composition of the present comparative embodiment was 37.5%.

### Embodiment 1

60.0 g of bio-based polyester polyol (obtained from the

copolymerization of succinic acid and 1,3-propanediol, and having the molecular weight of 3000), 10.0 g of petroleum-based polyester polyol (obtained from the copolymerization of phthalic anhydride, neopentyl glycol and 1,6-hexanediol, and having the molecular weight of 1000) and 5.0 g of petroleum-based polycaprolactone polyol (having the molecular weight of 4000) were placed in a reaction bottle, heated to 100° C. under mechanical stirring, and dried under reduced pressure. After the temperature was cooled to 60° C., 25.0 g of 4,4′-MDI (isocyanate/hydroxyl ratio is 3.20) was added for reaction. The isocyanate group content was detected according to the ASTM D5155 method to detect the reaction endpoint. The reaction was stopped, and the product was collected and packaged to obtain the moisture-curable hot melt adhesive composition of the present embodiment. Herein, the biomass content of the composition of the present embodiment was 60%.

### Embodiment 2

42.3 g of bio-based polyester polyol (obtained from the copolymerization of succinic acid and 1,3-propanediol, and having the molecular weight of 3000), 31.7 g of petroleum-based polyester polyol (obtained from the copolymerization of phthalic anhydride, neopentyl glycol and 1,6-hexanediol, and having the molecular weight of 1000) and 1.0 g of petroleum-based polycaprolactone polyol (having the molecular weight of 4000) were placed in a reaction bottle, heated to 100° C. under mechanical stirring, and dried under reduced pressure. After the temperature was cooled to 60° C., 25.0 g of 4,4′-MDI (isocyanate/hydroxyl ratio is 2.17) was added for reaction. The isocyanate group content was detected according to the ASTM D5155 method to detect the reaction endpoint. The reaction was stopped, and the product was collected and packaged to obtain the moisture-curable hot melt adhesive composition of the present embodiment. Herein, the biomass content of the composition of the present embodiment was 42.3%.

### Embodiment 3

41.0 g of bio-based polyester polyol (obtained from the

copolymerization of succinic acid and 1,3-propanediol, and having the molecular weight of 3000), 30.8 g of petroleum-based polyester polyol (obtained from the copolymerization of phthalic anhydride, neopentyl glycol and 1,6-hexanediol, and having the molecular weight of 1000) and 5.1 g of petroleum-based polycaprolactone polyol (having the molecular weight of 3000) were placed in a reaction bottle, heated to 100° C. under mechanical stirring, and dried under reduced pressure. After the temperature was cooled to 60° C., 23.1 g of 4,4′-MDI (isocyanate/hydroxyl ratio is 2.00) was added for reaction. The isocyanate group content was detected according to the ASTM D5155 method to detect the reaction endpoint. The reaction was stopped, and the product was collected and packaged to obtain the moisture-curable hot melt adhesive composition of the present embodiment. Herein, the biomass content of the composition of the present embodiment was 41.0%.

### Embodiment 4

52.6 g of bio-based polyester polyol (obtained from the copolymerization of sebacic acid and 1,4-butanediol, and having the molecular weight of 3000), 5.3 g of petroleum-based polyester polyol (obtained from the copolymerization of phthalic anhydride, neopentyl glycol and 1,6-hexanediol, and having the molecular weight of 1000) and 26.3 g of petroleum-based polycaprolactone polyol (having the molecular weight of 3000) were placed in a reaction bottle, heated to 100° C. under mechanical stirring, and dried under reduced pressure. After the temperature was cooled to 60° C., 15.8 g of 4,4′-MDI (isocyanate/hydroxyl ratio is 2.00) was added for reaction. The isocyanate group content was detected according to the ASTM D5155 method to detect the reaction endpoint. The reaction was stopped, and the product was collected and packaged to obtain the moisture-curable hot melt adhesive composition of the present embodiment. Herein, the biomass content of the composition of the present embodiment was 35.2%.

### Embodiment 5

50.2 g of bio-based polyester polyol (obtained from the copolymerization of sebacic acid and 1,4-butanediol, and having the molecular weight of 3000), 20.1 g of petroleum-based polyester polyol (obtained from the copolymerization of phthalic anhydride, neopentyl glycol and 1,6-hexanediol, and having the molecular weight of 1000) and 10.0 g of petroleum-based polycaprolactone polyol (having the molecular weight of 4000) were placed in a reaction bottle, heated to 100° C. under mechanical stirring, and dried under reduced pressure. After the temperature was cooled to 60° C., 19.7 g of 4,4′-MDI (isocyanate/hydroxyl ratio is 2.00) was added for reaction. The isocyanate group content was detected according to the ASTM D5155 method to detect the reaction endpoint. The reaction was stopped, and the product was collected and packaged to obtain the moisture-curable hot melt adhesive composition of the present embodiment. Herein, the biomass content of the composition of the present embodiment was 33.6%.

### Embodiment 6

20.0 g of bio-based polyester polyol (obtained from the copolymerization of succinic acid and 1,3-propanediol, and having the molecular weight of 3000), 50.0 g of petroleum-based polyester polyol (obtained from the copolymerization of phthalic anhydride, neopentyl glycol and 1,6-hexanediol, and having the molecular weight of 1000) and 5.0 g of petroleum-based polycaprolactone polyol (having the molecular weight of 4000) were placed in a reaction bottle, heated to 100° C. under mechanical stirring, and dried under reduced pressure. After the temperature was cooled to 60° C., 25.0 g of 4,4′-MDI (isocyanate/hydroxyl ratio is 1.73) was added for reaction. The isocyanate group content was detected according to the ASTM D5155 method to detect the reaction endpoint. The reaction was stopped, and the product was collected and packaged to obtain the moisture-curable hot melt adhesive composition of the present embodiment. Herein, the biomass content of the composition of the present embodiment was 20.0%.

### Tensile Test

The compositions of Comparative embodiment 1 and Embodiments 1 to 6 were preheated at 100° C. for 2 hours, and were applied onto a suitable substrate using a coating machine. The coating thickness was 0.20 mm, the aging time was 72 hours, and the aging environment humidity was 65%. Then, the material displacement and elongation were measured according to the ASTM D638 test method.

### Peel Strength Test

The moist-curable hot melt adhesive compositions obtained in the embodiments and comparative embodiment were processed at 120° C., and a roller coater, a blade coater, a spray coater, a gravure roller coater, an unfilled corner wheel coater, a T-die coater, an applicator, a dispenser, etc. may be used. According to the ASTM D2724 test method, the sample was cut into long strips with a width of 2.5 cm, and the peel strength was tested with a tensile machine.

### Shear Force Test

The compositions of Comparative embodiment 1 and Embodiments 1 to 6 were placed at a constant temperature of 100° C., and were applied onto the substrate into a 2.5 mm square frame with a thickness of 0.5 mm. Next, another substrate was attached, the aging temperature was 25° C., the humidity was 65%, and the aging time was 3 days. Then, a shear force test was performed according to the ASTM D1002 standard test method.

The test results are listed in Table 1 below. Among them, “◯” indicates material rupture, and “X” indicates adhesive separation. In Table 1 below, Embodiment is abbreviated as Ex., and Comparative embodiment is abbreviated as Comp. Ex.

TABLE 1

| | Comp. | | | | | | |
|---|---|---|---|---|---|---|---|
| | Ex. 1 | Ex. 1 | Ex. 2 | Ex. 3 | Ex. 4 | Ex. 5 | Ex. 6 |
| Tensile test | | | | | | | |
| Maximum stress | 36.7 | 165 | 76 | 50.6 | 284 | 300 | 55.2 |
| (kgf/cm²) | | | | | | | |
| Elongation (%) | 207 | 559 | 386 | 425 | 744 | 561 | 412 |
| Peel strength test | | | | | | | |
| (N/inch) | | | | | | | |
| Mesh fabric + Mesh | 1.0 | 2.9 | 2.9 | 3.9 | 3.9 | 4.9 | 3.9 |
| fabric | | | | | | | |
| Mesh fabric +TPU | 3.9 | 4.9 | 12.8 | 10.8 | 7.8 | 9.8 | 4.9 |
| Leather + Leather | ◯ | ◯ | ◯ | ◯ | ◯ | ◯ | ◯ |
| Shear force test | | | | | | | |
| (N/2.5 mm²) | | | | | | | |
| Wood sheet + Wood | X | ◯ | ◯ | ◯ | ◯ | ◯ | ◯ |
| sheet | | | | | | | |
| Glass sheet + Glass | 84 | 114 | 99 | 109 | 136 | 173 | 201 |
| sheet | | | | | | | |
| Glass sheet + | 77 | 105 | 79 | 127 | 144 | 187 | 286 |
| Aluminum sheet | | | | | | | |
| Glass sheet + | 74 | 119 | 84 | 106 | 186 | 153 | 160 |
| Stainless steel sheet | | | | | | | |
| Glass sheet + PC | 68 | 158 | 86 | 80 | 289 | 209 | 184 |
| sheet | | | | | | | |

As shown in the tensile test results in Table 1 above, compared with Comparative embodiment 1, the maximum stress and elongation of the adhesive films formed by the compositions of Embodiments 1 to 6 were significantly increased. In particular, the maximum stress value of the adhesive film formed by the composition of Embodiment 4 was eight times that of Comparative embodiment 1, and the elongation was four times that of Comparative embodiment 1. These results indicate that the composition formed by adding polycaprolactone polyol can not only significantly increase the maximum stress value of the material, but also increase the elongation, which is helpful for the applicability of the composition.

The substrates used in the peel strength test are common materials used in the textile industry, while the substrates used in the shear force test are common materials used in the woodworking and electronics industries. As shown in the results of the peel strength test and the shear force test in Table 1 above, the compositions of Embodiments 1 to 6 have better adhesion test data for common materials in various application fields than the composition of Comparative embodiment 1. These results indicate that the compositions formed by adding polycaprolactone polyol can effectively improve the adhesion of the compositions to various materials.

By adding polycaprolactone polyol to the moisture-curable hot melt adhesive composition provided by the present invention, the maximum stress or elongation of the formed adhesive material can be increased. In addition, the moist-curable hot melt adhesive composition provided by the present invention can exhibit good peel strength when used as an adhesive material, and can be applied to different industrial fields (for example, textiles, shoe materials, home decoration, electronics, automotive, construction, flooring, etc.) and improve the applicability thereof in coating and bonding.

Although the present disclosure has been explained in relation to its embodiment, it is to be understood that many other possible modifications and variations can be made without departing from the spirit and scope of the disclosure as hereinafter claimed.

1. A moisture-curable hot-melt adhesive composition, comprising a polymer obtained by reacting the following components:
20 wt % to 60 wt % of bio-based polyester polyol;
1 wt % to 30 wt % of polycaprolactone polyol;
5 wt % to 50 wt % of petroleum-based polyester polyol; and
15 wt % to 25 wt % of polyisocyanate,
wherein the bio-based polyester polyol comprises a product of a dicarboxylic acid derived from biomass and a diol derived from biomass or petroleum; and the dicarboxylic acid is sebacic acid, succinic acid, or a combination thereof.

2. The moisture-curable hot-melt adhesive composition of claim 1, wherein the diol is one selected from the group consisting of ethylene glycol, diethylene glycol, 1,3-propanediol, 1,2-propanediol, 1,3-butanediol, 1,4-butanediol, pentanediol, 2,4-diethyl-1,5-pentanediol, 3-methyl-1,5-pentanediol, hexanediol, neopentyl glycol, 1,4-cyclohexanediol, 1,10-decanediol, dimer diol, isosorbide and hexamethylene glycol, or a combination thereof.

3. The moisture-curable hot-melt adhesive composition of claim 1, wherein the petroleum-based polyester polyol comprises a product of a polybasic acid and a compound with two or more hydroxyl groups.

4. The moisture-curable hot-melt adhesive composition of claim 3, wherein the compound is one selected from the group consisting of ethylene glycol, diethylene glycol, 1,3-propanediol, 1,2-propanediol, 1,3-butanediol, 1,4-butanediol, pentanediol, 2,4-diethyl-1,5-pentanediol, 3-methyl-1,5-pentanediol, hexanediol, neopentyl glycol, 1,4-cyclohexanediol, 1,10-decanediol, dimer diol, isosorbide, hexamethylene glycol, glycerin and trimethylolpropane, or a combination thereof.

5. The moisture-curable hot-melt adhesive composition of claim 3, wherein the polybasic acid is one selected from the group consisting of succinic acid, adipic acid, glutaric acid, pimelic acid, suberic acid, dimer acid, sebacic acid, undecanedicarboxylic acid, lauric acid, hexahydroterephthalic acid, phthalic acid, phthalic anhydride, isophthalic acid and terephthalic acid, or a combination thereof.

6. The moisture-curable hot-melt adhesive composition of claim 1, wherein the bio-based polyester polyol has a molecular weight ranging from 1000 to 5000.

7. The moisture-curable hot-melt adhesive composition of claim 1, wherein the polycaprolactone polyol has a molecular weight ranging from 1000 to 5000.

8. The moisture-curable hot-melt adhesive composition of claim 1, wherein the polyisocyanate is one selected from the group consisting of 4,4′-methylene diphenyl diisocyanate, tolylene diisocyanate, 1,5-pentane diisocyanate, 1,5-naphthalene diisocyanate, hexamethylene diisocyanate, cyclohexane diisocyanate, isophorone diisocyanate, 4,4′-diisocyanato dicyclohexylmethane, m-xylylene diisocyanate, and meta-tetra-methylxylene diisocyanate, or a combination thereof.

9. The moisture-curable hot-melt adhesive composition of claim 1, wherein a biomass content of the polymer ranges from 20% to 60%.

10. A use of the moisture-curable hot-melt adhesive composition of claim 1, for adhesion of textile, wood, glass, metal, plastic or a combination thereof.
